(19) United States
(12) Patent Application Publication
(10) Pub. No.: US 2025/0001682 A1
(43) Pub. Date: Jan. 2, 2025

(54) APPARATUS AND METHOD FOR CONVEYING AN ELONGATE FIBER TOW

(71) Applicant: 9T LABS AG, Zürich (CH)

(72) Inventors: Lucien SEGESSEMANN, Zürich (CH); Tristan FASCHINGER, Zürich (CH); Thomas NETTER, Winterthur (CH)

(73) Assignee: 9T LABS AG, Zürich (CH)

(21) Appl. No.: 18/710,393

(22) PCT Filed: Nov. 15, 2022
(86) PCT No.: PCT/IB2022/060964

§ 371 Date: May 15, 2024

(30) Foreign Application Priority Data
Nov. 15, 2021 (WO) PCT/IB2021/060573

(51) Int. Cl. B29C 64/209; B22F 10/34; B22F 10/85; B22F 12/50; B22F 12/90; B29C 64/118; B29C 64/227; B29C 64/264; B29C 64/321; B29C 64/393; B33Y 10/00; B33Y 30/00; B33Y 50/02

(52) U.S. Cl. CPC B29C 64/209; B22F 10/34; B22F 10/85; B22F 12/50; B22F 12/90; B29C 64/118; B29C 64/227; B29C 64/264; B29C 64/321; B29C 64/393; B33Y 10/00; B33Y 30/00; B33Y 50/02

(57) ABSTRACT

One example provides a filament feeding device and a method for guiding a filament into an additive manufacturing apparatus, the filament feeding device comprising: a filament travel path; a filament buffer comprising a telescopic tubular assembly comprising a filament entrance at a first end of the tubular assembly and a filament exit at a second end of the tubular assembly, the tubular assembly comprising: a first tube having a first tube longitudinal centerline; and a second tube comprising a portion into which a portion of the first tube is telescopically inserted; and a position sensor; a controller connected to the position sensor; and a computer-readable non-volatile storage device, wherein the position sensor is configured for measuring a position of the first tube with respect to a reference point.

### FIELD

The present disclosure relates to devices and methods for conveying an elongate fiber tow onto a surface.

### BACKGROUND

Fiber-reinforced plastics (FRP), also called fiber-reinforced polymers, for example carbon fiber-reinforced plastics (CFRP) are widely used materials for lightweight structures, ranging from sports equipment, to automotive components, to aircraft structures. A method for manufacturing of FRP's comprises depositing fiber tows, for example preimpregnated tows, for example tapes, onto a substrate. The depositing is, for example, done by a robot, for example a manipulator comprising a tape dispensing end effector for additive manufacturing. A method for forming CFRP comprises depositing a filament or elongate fiber tow comprising, for example, elongate fibers.

The present disclosure addresses problems and limitations associated with the related art.

### SUMMARY

In view of the Background, there is a need to supply a filament at a speed that matches the demand at which the filament is deposited. In some applications, the filament is manufactured by the same system that is used to deposit the filament. However, the speed at which the filament is supplied or manufactured may not always equal the speed at which the filament is deposited. There is therefore a need for devices to improve matching of the supply rate to the deposition rate.

Aspects of the disclosure present a filament feeding device, for guiding a filament into an additive manufacturing apparatus, comprising: a filament travel path; a filament buffer comprising a telescopic tubular assembly comprising a filament entrance at a first end of the tubular assembly and a filament exit at a second end of the tubular assembly, the tubular assembly comprising: a first tube having a first tube longitudinal centerline; and a second tube comprising a portion into which a portion of the first tube is telescopically inserted; and a position sensor; a controller connected to the position sensor; and a computer-readable non-volatile storage device, wherein the position sensor is configured for measuring a position of the first tube with respect to a reference point.

For example, the position sensor is configured for measuring the position of the first tube with respect to the position of the second tube. For example, the position sensor is configured for measuring the position of the first tube with respect to the position of the second tube in a direction parallel to the longitudinal centerline of the first tube. For example, the position sensor comprises a linear sensor. For example, the position sensor comprises an optical sensor. For example, a portion of the telescopic tubular assembly wherein the first tube telescopes into the second tube comprises a straight portion of the first tube ahead of entry into the second tube. For example, a portion of the first tube is positioned in sliding contact within a first clamp comprising an inner width that is greater than the outer width of the first tube by at most 1 mm. For example, a portion of the second tube is fastened within a second clamp to a chassis. For example, a portion of the first tube is positioned in sliding contact within a first clamp comprising an inner width that is greater than the outer width of the first tube by at most 2 mm and wherein the first clamp has a position that is fixed with respect to the portion into which a portion of the first tube is telescopically inserted. For example, the internal fastening axis of the first clamp is coaxial with the internal fastening axis of the second clamp. For example, one or more of the first tube and the second tube comprises a polytetrafluoroethylene material. For example, one or more of the first tube and the second tube comprises a coating comprising a polytetrafluoroethylene material. For example, the first tube has an internal diameter comprised in a range from 0.5 mm to 10 mm. For example, one or more of the first tube and the second tube has a wall thickness comprised in a range from 0.3 mm to 3 mm. For example, the internal diameter of the second tube is greater than the external diameter of the first tube by a margin comprised in a range from 15% to 100%.

For example, a portion of the path of the first tube comprises an expansion offset. For example, the expansion offset comprises a straight portion ending at the end of the first tube that is telescopically inserted into the second tube. For example, the first tube has a length comprised between 0.2 m and 5 m. For example, the second tube has a length comprised between 0.05 m and 5 m.

For example, a traction motor is driving one or more roller comprising a groove having a rectangular cross-section intersecting at least a portion of the filament travel path for feeding a filament into the first tube. For example, the traction motor is positioned up the filament travel path with respect to the first tube. For example, the first tube comprises an expansion offset comprised in a plane that is parallel to one of the faces of the groove having a rectangular cross-section. For example, the first tube forms a first curve forming an arc of at least 60°, the axis of revolution of which is parallel to a side of the groove having a rectangular cross-section. For example, the controller is further connected to the traction motor. For example, the storage device further comprises computer-readable instructions for adjusting the speed of the traction motor for adjusting the translation speed of the filament. For example, the adjusting the speed of the traction motor is a function of the one or more measurement acquired from the position sensor.

For example, the device comprises a sensor for measuring the speed at which the filament travels. For example, the filament speed sensor is positioned down the filament travel path from a portion of the telescopic tubular assembly wherein the first tube telescopes into the second tube. For example, the controller is further connected to the filament speed sensor. For example, the instructions for adjusting the speed of the traction motor further comprise instructions to acquire one or more measurement from the filament speed sensor.

For example, the device comprises a heater, for supplying heating radiation to a fiber tow in progressing motion towards the filament buffer, a radiative outlet of the heater being directed towards the filament travel path at a position up the filament travel path from the first end of the tubular assembly. For example, the storage device comprises computer-readable instructions for adjusting the radiation supplied by the heater towards a portion of the filament travel path as a function of one or more position measurement acquired from the position sensor. For example, the computer-readable instructions further comprise instructions for adjusting the radiation as a function of a rate of change of the one or more position measurement.

For example, the device comprises an additive manufacturing apparatus comprising a foot for depositing the filament fed into the apparatus onto an object surface. For example, the additive manufacturing apparatus comprises a pinch roller assembly comprising one or more pinch roller assembly motor connected to the controller. For example, the storage device further comprises instructions for adjusting the speed of the pinch roller assembly motor. For example, the storage device further comprises instructions for adjusting the speed of one or more of the traction motor and the pinch roller assembly motor as a function of one or more measurement acquired from one of more of one or more position measurement acquisition and one or more filament speed sensor measurement acquisition. For example, the foot comprises a groove for guiding the filament towards an object surface onto which the filament is to be deposited. For example, the foot is coupled to a rotating support connected to a foot rotation motor and comprising an orifice for guiding a filament to the foot. For example, the controller comprises instructions wherein the speed at which the foot rotation motor is actuated is a function of one or more measurements from the position sensor. For example, the orifice intersects the axis of rotation of the rotating support. For example, the foot comprises a groove for guiding the filament towards the object surface and the groove's cross section intersects the axis of rotation of the rotating support. For example, the groove comprises one or more of a rectangular cross-section and a trapezoidal cross-section.

The disclosure also presents a method for guiding a filament into an additive manufacturing apparatus, comprising: supplying the filament into a first tube telescoping into a second tube of a filament feeding device; measuring one or more position of the first tube with respect to a reference point; and adjusting the translation speed of the filament, wherein the translation speed is a function of the one or more measurement of the position of the first tube.

For example, the one or more measurement of the position of the first tube is measured with respect to the position of the second tube. For example, the one or more measurement of the position of the first tube is measured with respect to the position of the second tube in a direction parallel to the longitudinal centerline of the first tube. For example, the one or more measurement of the position of the first tube is measured along a straight portion of the first tube at a position ahead of entry into the second tube. For example, the first tube is in sliding contact within a first clamp and the second tube is fastened within a second clamp. For example, the first tube is forming an expansion offset sliding into the first clamp and into the second tube. For example, the filament comprises a rectangular cross-section and the plane into which the expansion offset is formed is parallel to a side face of the filament. For example, the filament comprises a rectangular cross-section. For example, the width of the filament is comprised in a range from 0.2 mm to 10 mm. For example, the internal width of the first tube is greater than the width of the filament by a coefficient comprised in a range from 1.1 to 20. For example, the method comprises pulling the filament with a traction motor driving one or more roller comprising a groove and feeding the filament into the first tube. For example, the method comprises adjusting the speed of the traction motor for adjusting the translation speed of the filament fed into the first tube. For example, the adjusting the speed of the traction motor is a function of the one or more measurement acquired from the position sensor. For example, the adjusting the speed of the traction motor comprises measuring the speed at which the filament travels. For example, the measuring the speed comprises acquiring measurements from a filament speed sensor.

For example, the method comprises adjusting a radiation supplied by a heater towards a portion of the filament travel path at a position ahead of the first tube. For example, the adjusting the radiation is a function of one or more position measurement acquired from the position sensor. For example, the adjusting the radiation is a function of a rate of change of the one or more position measurement.

For example, the method comprises feeding the filament into an additive manufacturing apparatus comprising a foot for depositing the filament fed into the apparatus onto an object surface. For example, the method comprises feeding the filament into a pinch roller assembly comprising one or more pinch roller assembly motor of the additive manufacturing apparatus and adjusting the speed of the pinch roller assembly motor. For example, one or more of the adjusting the speed of one or more of the traction motor and the pinch roller assembly motor is a function of one or more measurement acquired from one of more of one or more position measurement acquisition and one or more filament speed sensor measurement acquisition. For example, the method comprises guiding the filament within a groove comprised in the foot towards an object surface onto which the filament is to be deposited. For example, the method comprises rotating the foot around an axis intersected by the cross-section of the groove. For example, adjusting the speed of one or more of the traction motor and the pinch roller assembly motor is at least a function of one or more of the angle of rotation of the foot and the rate of rotation of the foot.

Furthermore, the disclosure presents a computer-readable non-volatile storage device comprising executable instructions that, when executed by one or more controller processor of a filament feeding device, cause the device to at least: acquire one or more position measurement from a position sensor configured to measure the position of a first tube telescoping into a second tube; and adjust the speed of a traction motor feeding a filament into the first tube.

For example, the adjusting the speed of a traction motor is a function of the one or more measurement of the position of the first tube. For example, the instructions comprise instructions for acquiring measurements from a filament speed sensor. For example, the instructions comprise instructions for adjusting a radiation supplied by a heater towards a portion of the filament travel path at a position ahead of the first tube. For example, the instructions comprise instructions for adjusting the radiation as a function of one or more position measurement acquired from the position sensor. For example, the instructions comprise instructions for adjusting the radiation as a function of a rate of change of the one or more position measurement.

For example, the instructions comprise instructions for adjusting the speed of one or more of the traction motor and a pinch roller assembly motor of an additive manufacturing apparatus into which the filament is fed from the second tube as a function of one or more measurement acquired from one of more of one or more position measurement acquisition and one or more filament speed sensor measurement acquisition. For example, the instructions comprise instructions for rotating a foot of the additive manufacturing apparatus for depositing the filament onto an object surface. For example, the instructions for adjusting the speed of one or more of the traction motor and the pinch roller assembly motor comprise one or more function of one or more of the angle of rotation of the foot and the rate of rotation of the foot.

### BRIEF DESCRIPTION OF DRAWINGS

FIG. 1A is a side view of a filament- or tow-forming assembly.

FIG. 1B is a top view of a filament or tow buffer assembly and a controller.

FIG. 1C is a side view of an additive manufacturing apparatus.

FIG. 2 is a block diagram of a method or set of instructions for controlling a system comprising a filament-forming device and an additive manufacturing apparatus.

FIG. 3 is a graph describing a command to adjust a change in radiation of a heater as a function of a change in position of a tube comprised in a telescopic buffer.

FIG. 4 is a front view of a pinch roller assembly comprising a rectangular groove.

FIG. 5 is a perspective view of a rotating foot assembly of an additive manufacturing apparatus.

### DETAILED DESCRIPTION

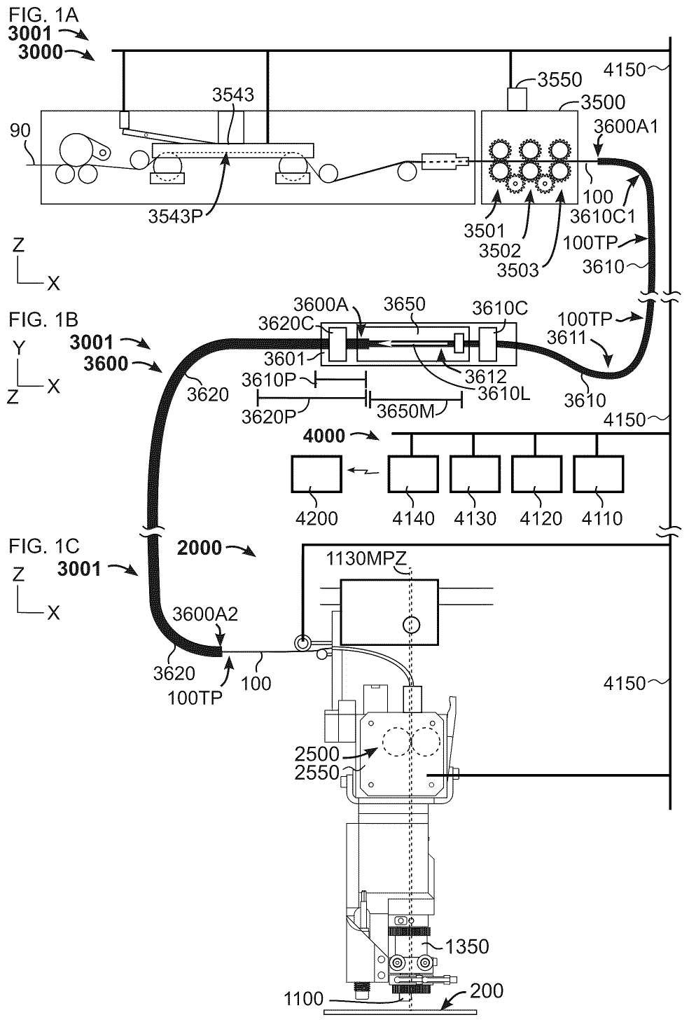

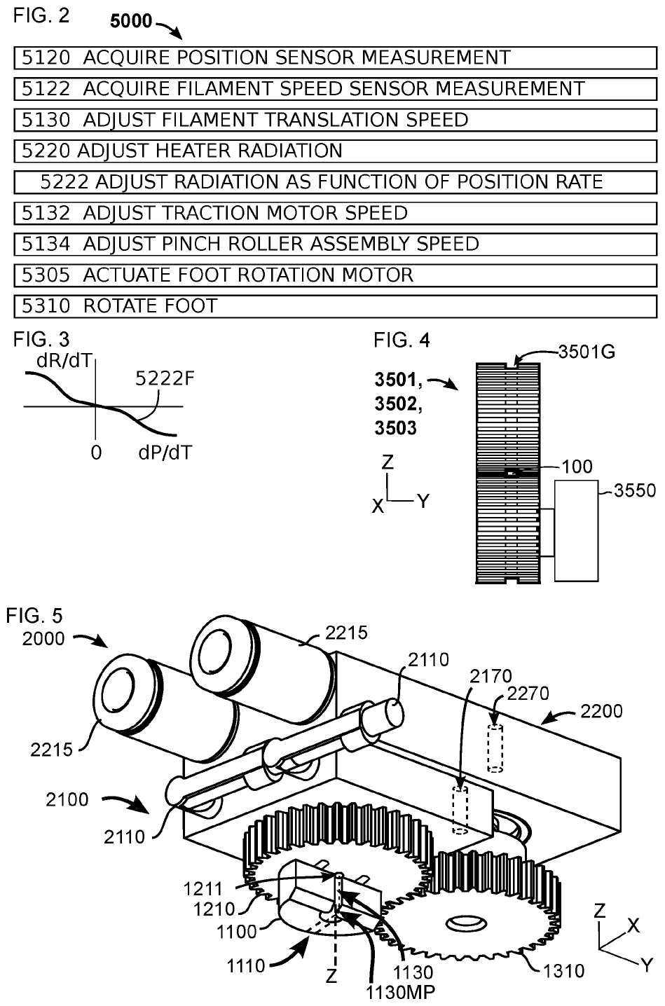

FIG. 1A is a side view of a filament- or tow-forming assembly 3000. FIG. 1B is a top view of a filament or tow buffer assembly 3600 and a computer system 4000. FIG. 1C is a side view of an additive manufacturing apparatus or system 2000. The filament-forming assembly 3000, the filament buffer assembly 3600 and the additive manufacturing apparatus 2000 are linked to each other by a filament travel path 100TP conveying a filament 100 from the filament-forming assembly 3000, via the filament buffer assembly 3600 and the additive manufacturing apparatus 2000 to an object surface 200 under the control of the computer system 4000.

FIGS. 1A and 1B present the filament feeding device 3001, for guiding a filament 100 into the additive manufacturing apparatus 2000. The filament feeding device comprises, for example, a filament travel path 100TP. The filament feeding device comprises, for example, a filament buffer 3600. For example, the filament buffer comprises a telescopic tubular assembly 3600A. For example, the telescopic tubular assembly comprises a filament entrance at a first end 3600A1 of the tubular assembly and a filament exit at a second end 3600A2 of the tubular assembly. For example, the tubular assembly comprises: a first tube 3610 having a first tube longitudinal centerline 3610L; and a second tube 3620. For example, the second tube comprises a portion 3620P into which a portion 3610P of the first tube 3610 is telescopically inserted.

For example, the filament 100 comprises one or more of: carbon fiber, a glass fiber, an aramid fiber, a basalt fiber, a metal fiber, and a natural fiber, for example an acetate fiber. For example, the filament is a tow comprising continuous fibers. For example, the tow is impregnated with a thermoplastic adhesive. For example, the tow is configured as a tape. For example, a thermoplastic adhesive comprises one or more of a polyaryletherketone (PAEK), for example a polyether ether ketone (PEEK), for example a polyetherketoneketone (PEKK), a polyetherimide (PEI), an acrylonitrile butadiene styrene (ABS), a nylon, a polybutylene terephthalate (PBT), a polycarbonate (PC), a polycarbonate-ABS (PC-ABS), a polyether sulfone (PES), a polyethylene (PE), a polyethylene terephthalate (PET), a polyphenylene sulfide (PPS), a polyphenylsulfone (PPSU), a polyphosphoric acid (PPA), a polypropylene (PP), a polysulfone (PSU), a polyurethane (PU), and a polyvinyl chloride (PVC). For example, a filament comprising fibers and a thermoplastic displaced inside a tube develops friction forces against the material inside the tube that depends on one or more of the surface of the filament contacting the inside of the tube; the surface roughness of the filament; the fiber material; the thermoplastic material; the temperature; the curvature of the filament; the twist of the filament; the filament's speed; the diameter of the tube; and the curvature of the tube. For example, friction forces cause changes in the speed of conveying the filament that are difficult to predict. A filament buffer assembly 3600 assists with the conveying of the filament 100.

For example, the filament buffer 3600 comprises a position sensor 3650. For example, the position sensor is configured to measure a position of the first tube 3610. For example, the position sensor is configured to measure a position of the first tube 3610 along the tube's longitudinal axis. For example, the position sensor comprises a linear sensor. For example, the position sensor is connected to the first tube. In another example, the position sensor comprises one or more of an optical sensor, a magnetic sensor, and an electromagnetic sensor, configured to measure a displacement of the first tube 3610 without contact. For example, the position sensor comprises one or more of: a potentiometer, for example a linear potentiometer; a hall effect sensor, for example a linear magnetic hall effect sensor; a magnetostrictive position sensor, for example a linear magnetostrictive position sensor; an encoder, for example an incremental linear encoder; an inductive position sensor, for example a linear inductive position sensor; a linear variable differential transformer (LVDT) sensor; a draw-wire sensor; an eddy current sensor; a capacitive position sensor; a single point laser sensor; a laser scanning sensor; and a fiber optic linear position sensor.

For example, the filament buffer 3600 comprises a controller 4110. For example, the controller comprises a digital processor. For example, the computer system 4000 comprises one or more of a digital processor 4110, a non-transitory computer-readable non-volatile storage device or medium 4120, a user interface device 4130, a data bus 4150 connected to one or more sensor 3650 and one or more actuator 3550, 2550, for example comprising one or more motor, and a communication interface device 4140 for transferring data between one or more of the digital processor 4110, the computer-readable non-volatile storage device 4120, the data bus 4150, the user interface device 4130, and one or more external systems 4200 external to the system comprising one or more of a processor, a storage device, a user interface, an actuator, and a sensor.

For example, the controller is connected to the position sensor 3650. For example, the filament buffer 3600 comprises a computer-readable non-volatile storage device 4120. For example, the position sensor 3650 is configured for measuring a position 3650P of the first tube 3610 with respect to a reference point. For example, the position sensor 3650 is configured for measuring the position of the first tube 3610 with respect to the position of the second tube 3620. For example, the position sensor 3650 is configured for measuring the position of the first tube 3610 with respect to the position of the second tube 3620 in a direction parallel to the longitudinal centerline 3610L of the first tube.

For example, a portion of the telescopic tubular assembly 3600A wherein the first tube 3610 telescopes into the second tube 3620 comprises a straight portion of the first tube ahead of entry into the second tube. In this context, the word ahead corresponds, with respect to a direction of supplying a filament 100 into the filament buffer 3600, to a position that is before the filament buffer.

For example, a portion of the first tube 3610 is positioned in sliding contact within a first clamp 3610C. For example, the first clamp comprises an inner width that is greater than the outer width of the first tube by, for example, at most 2 mm. For example, a portion of the second tube 3620 is fastened within a second clamp 3620C. For example, the second clamp is connected to a chassis 3601. For example, a portion of the first tube 3610 is positioned in sliding contact within a first clamp 3610C comprising an inner width that is greater than the outer width of the first tube by at most 2 mm. For example, the first clamp has a position that is fixed with respect to the portion 3620P into which a portion 3610P of the first tube 3610 is telescopically inserted. For example, the internal fastening axis of the first clamp 3610C is coaxial with the internal fastening axis of the second clamp 3620C.

For example, one or more of the first tube and the second tube comprises a polytetrafluoroethylene (PTFE) material. For example, one or more of the first tube and the second tube comprises a coating comprising a polytetrafluoroethylene (PTFE) material. For example, the first tube has an internal diameter comprised in a range from 0.5 mm to 10 mm, for example from 1 mm to 5 mm, for example from 1.7 mm to 3 mm, for example from 1.9 mm to 2.1 mm. For example, one or more of the first tube and the second tube has a wall thickness comprised in a range from 0.3 mm to 3 mm, for example from 0.5 mm to 2 mm, for example from 0.9 mm to 1.1 mm. For example, the internal diameter of the second tube is greater than the external diameter of the first tube by a margin comprised in a range from 15% to 100%, for example from 20% to 80%, for example from 50% to 70%, for example from 55% to 65%. For example the first tube has an inner width or diameter of 2 mm and an external diameter of 3 mm. For example the second tube has an inner width or diameter of 5 mm and an external diameter of 6 mm.

For example, the first tube's motion is constrained to a sliding motion within a first clamp 3610C at a position close to the position sensor 3650, for example within 10 cm. For example, a portion of the path of the first tube 3610 comprises an expansion offset 3611 extending along a portion of the path ahead of the first clamp 3610C. For example, the path of the expansion offset comprises a path shaped as a question mark wherein the stem of the question mark feeds into the first clamp 3610C. In another example (not shown), the path of the expansion offset comprises an S shape. In yet another example (not shown), the path of the expansion offset comprises a U shape. For example, the expansion offset 3611 comprises a straight portion 3612 ending at the end of the first tube 3610 that is telescopically inserted into the second tube 3620. For example, the first tube 3610 has a length comprised in a range from 0.2 m and 5 m, for example from 0.5 m to 3 m, for example from 1 m to 2 m. For example, the second tube 3620 has a length comprised in a range from 0.05 m and 5 m, for example from 0.1 m to 3 m, for example from 0.5 m to 2.5 m, for example from 1 m to 2 m.

For example, the filament buffer 3600 comprises a traction motor 3550 driving one or more roller 3501, 3502, 3503, for example one or more pinch roller assembly 3501, 3502, 3503. For example, one or more roller comprises a groove 3501G having a rectangular cross-section intersecting at least a portion of the filament travel path 100TP. For example, a method for feeding a filament 100 into the first tube 3610 comprises using the traction force of the one or more roller or pinch roller 3501, 3502, 3503. For example, the traction motor 3550 is positioned up the filament travel path 100TP with respect to the first tube 3610.

For example, the first tube 3610 comprises an expansion offset 3611 comprised in a plane that is parallel to one of the faces of the groove 3501G having a rectangular cross-section of one or more roller or pinch roller. For example, the path of the first tube comprises one or more curved and smooth change in direction guiding the filament onto one or more plane that is one or more of parallel and orthogonal to one of the faces of the groove 3501G. Such a guiding arrangement, for example, provides a method for a filament having a rectangular cross-section to be guided to slide continuously within the first tube against corners of the filament's cross section while diminishing filament twisting and friction discontinuities during translation within the first tube. Continuous friction, for example progressive, without jumps or hysteresis, within the first tube ensures a continuous motion of the first tube with respect to the second tube and reduces the probability of the occurrence of filament jumps within the tube. For example, the first tube 3610 forms a first curve 3610C1 forming an arc of at least 60°, the axis of revolution of which is parallel to a side of the groove 3531BG having a rectangular cross-section.

For example, the controller 4110 is connected to the traction motor 3550, for example via a wired or wireless data communication network 4150. For example, the non-volatile data storage device 4120 comprises computer-readable instructions 5000 for adjusting the speed 5132 of the traction motor 3550 for adjusting the translation speed 5130 of the filament 100. For example, adjusting the speed 5132 of the traction motor is a function of one or more measurement acquired from the position sensor 3650.

For example, the filament buffer 3600 comprises a sensor 2712, for example a linear sensor, for example a contactless sensor, for measuring the speed 5122 at which the filament travels. For example, the filament speed sensor 2712 is positioned down the filament travel path from a portion of the telescopic tubular assembly 3600A wherein the first tube 3610 telescopes into the second tube 3620. For example, the controller 4110 is connected to the filament speed sensor 2712, for example via the communication network 4150. For example, the instructions for adjusting the speed 5132 of the traction motor 3550 comprise instructions to acquire 5122 one or more measurement from the filament speed sensor 2712.

For example, the filament feeding device 3001, for example the filament forming assembly 3000, comprises a heater 3543, for supplying heating radiation to a fiber tow 90 in progressing motion towards the filament buffer 3600. For example, the fiber tow is configured as a tape that is pre-impregnated with a thermoplastic resin. For example, the heater 3543 comprises one or more of: a resistive heating element; a conductive heating element, for example a heated roller; and a laser. For example, a radiative outlet 3553 of the heater 3543 is directed towards the filament travel path 100TP at a position up the filament travel path from the first end 3600A1 of the tubular assembly. For example, the storage device 4120 comprises computer-readable instructions 5000 for adjusting the radiation 5220 supplied by the heater towards a portion 3543P of the filament travel path 100TP. For example, the adjusting the radiation 5220 is a function of one or more position measurement 3650M acquired from the position sensor 3650. For example, the computer-readable instructions 5000 comprise instructions for adjusting the radiation 5222 as a function 5222F of a rate of change of the one or more position measurement 3650M.

FIG. 5 presents a perspective view of a rotating foot assembly of an additive manufacturing apparatus 2000. The additive manufacturing apparatus 2000 comprises, for example, a foot shaft housing 2100, characterized by a foot shaft's axis of rotation Z. For example, the foot shaft's axis of rotation Z is orthogonal to a straight foot segment 1110 and comprised in the midplane 1130MP of the groove 1130 used for guiding the filament onto an object surface 200. For example, the foot shaft housing 2100 comprises one or more sources of heat 2110. A source of heat 2110 comprises, for example, one or more of: one or more electrically resistive elements; and one or more inductive elements. For example, the foot shaft housing 2100 comprises one or more comprises one or more temperature sensor 2170. For example, the system 2000 comprises a heat exchanger housing 2200. For example, the heat exchanger housing 2200 comprises one or more temperature sensor 2270. For example, the heat exchanger housing 2200 comprises one or more port 2215 for driving a fluid, for example a cooling fluid, one or more of into and out of the heat exchanger housing.

For example, the additive manufacturing apparatus 2000 comprises a foot 1100 for depositing the filament 100 fed into the apparatus onto an object surface 200. For example, the additive manufacturing apparatus 2000 comprises a pinch roller assembly 2500 comprising one or more pinch roller assembly motor 2550 connected to the controller 4110. For example, the storage device 4120 comprises instructions for adjusting the speed 5134 of the pinch roller assembly motor 2550. For example, the storage device 4120 comprises instructions for adjusting the speed 5132, 5134 of one or more of the traction motor 3550 and the pinch roller assembly motor 2550 as a function of one or more measurement acquired from one of more of one or more position measurement 3650M acquisition 5120 and one or more filament speed sensor measurement acquisition 5122.

For example, the foot 1100 comprises a groove 1130 for guiding the filament 100 towards an object surface 200 onto which the filament is to be deposited. For example, the foot 1100 comprises a foot surface 1150, for one or more of guiding and pressing the filament 100 onto the object surface 200, the foot surface comprising a straight foot segment 1110 for applying the filament 100 onto the object surface 200. For example, the foot 1100 is coupled to a rotating support 1210. For example, the rotating support 1210 comprises an orifice 1211 for guiding a filament 100 to the foot 1100.

For example, the rotating support 1210 is connected to a foot rotation motor 1350. For example, the foot rotation motor rotates the foot, guiding the filament for depositing the filament in a curved path. For example, forming a curved path requires reducing the speed at which the filament is supplied and, for example, causes a displacement of the first tube 3610 with respect to the second tube 3620. For example, the storage device 4120 further comprises instructions for adjusting the speed of the foot rotation motor 1350 as a function of one or more position measurement 3650M. For example, the storage device 4120 further comprises instructions for adjusting the speed at which the foot rotation motor 1350 is actuated 5305 as a function of one or more of the speed of the traction motor 3550 and the pinch roller assembly motor 2550. For example, the foot 1100 is coupled to the rotating support 1210 connected to a foot rotation motor 1350 and the storage device 4120 further comprises instructions for adjusting the speed of the foot rotation motor 1350 as a function of one or more position measurement 3650M and one or more of the speed of the traction motor 3550 and the pinch roller assembly motor 2550.

For example, the controller 4110 comprises instructions wherein the speed at which the foot rotation motor 1350 is actuated 5305 is a function of one or more measurements from the position sensor 3650. For example, the controller comprises instructions to prevent actuation of the foot rotation motor if the position sensor provides a value greater than or lower than a predefined threshold. For example, the instructions are stored on the computer-readable non-volatile storage device 4120 For example, the orifice 1211 intersects the axis of rotation Z of the rotating support 1210. For example, the groove's cross section intersects the axis of rotation Z of the rotating support 1210. For example, For example, a drive shaft to actuate the rotating support 1210 comprises a pinion 1310 that is coupled with the a pinion serving, for example as the rotating support 1210. For example, the groove 1130 comprises one or more of a rectangular cross-section and a trapezoidal cross-section.

For example, the filament feeding device 3001 provides a toolchain device and corresponding operating method for solving the problem smoothly feeding, buffering, and monitoring a filament 100 that has a rectangular cross-section into a directionally-adjustable foot. Continuous printing of an elongated filament along curves and loops contributes to building-up twisting forces within the filament that is being delivered and deposited onto the object surface 200. For example, the twist built-up along the filament is propagated from the foot to the buffer and distributed along the filament path. For example, propagation of the twist build-up along the tube forms, for example in comparison to a calibration or look-up table, a method to relate changes in measurements of the position of the first tube with the twist built up in the filament due to the deposition trajectory and velocity of the additive manufacturing apparatus.

For example, a method 5000 for guiding a filament 100 into an additive manufacturing apparatus 2000, comprises: supplying the filament 100 into the first tube 3610 telescoping into the second tube 3620 of the filament feeding device 3001; measuring one or more position 3650P of the first tube 3610 with respect to a reference point; and adjusting the translation speed 5130 of the filament 100. For example, adjusting the translation speed is a function of the one or more measurement of the position 3650P of the first tube 3610. For example, the one or more measurement of the position 3650P of the first tube 3610 is measured with respect to the position of the second tube 3620, for example in a direction parallel to the longitudinal centerline 3610L of the first tube. For example, the one or more measurement of the position 3650P of the first tube 3610 is measured along a straight portion of the first tube at a position 3650M ahead of entry into the second tube. For example, the position 3650M extends from the entry of the second tube to a distance ahead of the entry in a range from 0.04 m to 0.8 m, for example from 0.08 m to 0.5 m, for example from 0.1 m to 0.3 m, for example from 0.1 m to 0.2 m.

For example, the first tube 3610 is in sliding contact within a first clamp 3610C and the second tube is fastened within a second clamp 3620C. For example, the first tube 3610 is forming an expansion offset 3611 sliding into the first clamp 3610C and into the second tube 3620. For example, the filament 100 comprises a rectangular cross-section. For example, the plane into which the expansion offset 3611 is formed is parallel to a side face of the filament. For example, the width of the filament 100 is comprised in a range from 0.2 mm to 10 mm, for example from 0.4 mm to 5 mm, for example from 0.4 mm to 3 mm, for example from 0.4 mm to 2 mm, for example from 0.4 mm to 1 mm, for example from 0.45 mm to 0.6 mm.

For example, the internal width of the first tube 3610 is greater than the width of the filament 100 by a coefficient comprised in a range from 1.1 to 20, for example from 1.5 to 15, for example from 1.5 to 10, for example from 2 to 10, for example from 2 to 5, for example from 2.5 to 3.5, for example from 2.8 to 3.2.

For example, the method for guiding a filament comprises pulling the filament 100 with a traction motor 3550. For example, the method comprises driving one or more roller 3501, 3502, 3503 comprising a groove 3501G. For example, the method comprises feeding the filament 100 into the first tube 3610. For example, the method comprises adjusting the speed 5132 of the traction motor 3550 for adjusting the translation speed 5130 of the filament 100 fed into the first tube 3610. For example, the adjusting the speed 5132 of the traction motor 3550 is a function of the one or more measurement acquired from the position sensor 3650. For example, the adjusting the speed 5132 of the traction motor comprises measuring the speed 5122 at which the filament 100 travels. For example, the measuring the speed 5122 comprises acquiring measurements from a filament speed sensor 2712.

For example, the method comprises adjusting a radiation 5220 supplied by a heater towards a portion 3543P of the filament travel path 100TP at a position ahead of the first tube 3610. For example, the adjusting the radiation 5220 is a function of one or more position measurement 3650M acquired from the position sensor 3650. For example, the adjusting the radiation 5220 is a function 5222F of a rate of change of the one or more position measurement 3650M.

For example, the method comprises feeding the filament 100 into an additive manufacturing apparatus 2000 comprising a foot 1100 for depositing the filament 100 fed into the apparatus onto a substrate or object surface 200. For example, the method comprises feeding the filament into a pinch roller assembly 2500 comprising one or more pinch roller assembly motor 2550 of the additive manufacturing apparatus 2000 and adjusting the speed 5134 of the pinch roller assembly motor 2550. For example, one or more of the adjusting the speed 5132, 5134 of one or more of the traction motor 3550 and the pinch roller assembly motor 2550 is a function of one or more measurement acquired from one of more of one or more position measurement 3650M acquisition 5120 and one or more filament speed sensor measurement acquisition 5122.

For example, the method comprises guiding the filament 100 within a groove 1130 comprised in the foot 1100 towards an object surface 200 onto which the filament is to be deposited. For example, the method comprises rotating 5310 the foot 1100 around an axis intersected by the cross-section of the groove 1130. For example, adjusting the speed of one or more of the traction motor 3550 and the pinch roller assembly motor 2550 is at least a function of one or more of the angle of rotation of the foot 1100 and the rate of rotation of the foot.

For example, a computer-readable non-volatile storage device 4120 comprises executable instructions 5000 that, when executed by one or more controller processor 4110 of a filament feeding device 3001, cause the device to at least acquire 5120 one or more position measurement 3650P from a position sensor configured to measure the position of a first tube 3610 telescoping into a second tube 3620; and adjust 5130 the speed of a traction motor 3550 feeding a filament 100 into the first tube.

For example, in the instructions the adjusting the speed of a traction motor 3550 is a function of the one or more measurement of the position 3650P of the first tube 3610. For example, the instructions comprise instructions for acquiring 5122 measurements from a filament speed sensor 2712. For example, the instructions comprise instructions for adjusting a radiation 5220 supplied by a heater towards a portion 3543P of the filament travel path 100TP at a position ahead of the first tube 3610. For example, the instructions comprise instructions for adjusting the radiation 5220 as a function of one or more position measurement 3650M acquired from the position sensor 3650. For example, the instructions comprise instructions for adjusting the radiation 5220 as a function 5222F of a rate of change of the one or more position measurement 3650M.

For example, the instructions comprise instructions for adjusting the speed 5132, 5134 of one or more of the traction motor 3550 and a pinch roller assembly motor 2550 of an additive manufacturing apparatus 2000 into which the filament 100 is fed from the second tube 3620 as a function of one or more measurement acquired from one of more of one or more position measurement 3650M acquisition 5120 and one or more filament speed sensor 2712 measurement acquisition 5122.

For example, the instructions comprise instructions for rotating 5310 a foot 1100 of the additive manufacturing apparatus 2000 for depositing the filament 100 onto an object surface 200. For example, the instructions for adjusting the speed of one or more of the traction motor 3550 and the pinch roller assembly motor 2550 are comprise one or more function of one or more of the angle of rotation of the foot 1100 and the rate of rotation of the foot.

The specification and drawings are, accordingly, to be regarded in an illustrative rather than a restrictive sense. It will, however, be evident that various modifications and changes are, for example, made thereunto without departing from the broader spirit and scope of the disclosure as set forth in the claims. Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions and equivalents falling within the spirit and scope of the invention, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this disclosure are described herein, including the best mode known to the inventors for carrying out the invention. Variations of those preferred embodiments become, for example, apparent upon reading the foregoing description. The inventors expect skilled artisans to employ such variations as appropriate and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-36. (canceled)

37. A filament feeding device, for guiding a filament into an additive manufacturing apparatus, the filament feeding device comprising:
a filament travel path;
a filament buffer comprising a telescopic tubular assembly having a filament entrance at a first end of the tubular assembly and a filament exit at a second end of the tubular assembly, the tubular assembly comprising:
a first tube having a first tube longitudinal centerline; and
a second tube comprising a portion into which a portion of the first tube is telescopically inserted;
a position sensor to measure a position of the first tube with respect to a reference point;
a controller connected to the position sensor; and
a computer-readable non-volatile storage device to store computer-readable instructions that when executed by the controller cause the controller to adjust a radiation supplied by a heater towards a portion of the filament travel path at a position ahead of the first tube as a function of one or more position measurements acquired from the position sensor.

38. The filament feeding device of claim 37, wherein the position sensor is configured to measure the position of the first tube with respect to the position of the second tube.

39. The filament feeding device of claim 37, wherein the position sensor comprises a linear sensor.

40. The filament feeding device of claim 37, wherein a portion of the first tube is positioned in sliding contact within a first clamp comprising an inner width that is greater than an outer width of the first tube by at most 1 mm.

41. The filament feeding device of claim 37, wherein a portion of the second tube is fastened within a second clamp to a chassis.

42. The filament feeding device of claim 37, wherein the internal diameter of the second tube is greater than the external diameter of the first tube by a margin comprised in a range from 15% to 100%.

43. The filament feeding device of claim 37, further comprising a traction motor driving one or more roller comprising a groove having a rectangular cross-section intersecting at least a portion of the filament travel path for feeding a filament into the first tube.

44. The filament feeding device of claim 43, wherein the first tube forms a first curve forming an arc of at least 60°, the axis of revolution of which is parallel to a side of the groove having a rectangular cross-section.

45. The filament feeding device of claim 43, wherein the controller is further connected to the traction motor.

46. The filament feeding device of claim 45, wherein the computer-readable instructions further cause the controller to adjust the speed of the traction motor to adjust the translation speed of the filament.

47. The filament feeding device of claim 46, further comprising a sensor for measuring the speed at which the filament travels and wherein the controller is further connected to the sensor.

48. The filament feeding device of claim 37, further comprising an additive manufacturing apparatus comprising:
a foot configured to deposit the filament fed into the apparatus onto an object surface; and
a pinch roller assembly comprising one or more pinch roller assembly motors connected to the controller, and
wherein the computer readable instructions further cause the controller to adjust the speed of one or more of the traction motors and the pinch roller assembly motors as a function of one or more measurements acquired from one of more of one or more position measurement acquisitions and one or more filament speed sensor measurement acquisitions.

49. The filament feeding device of claim 48, wherein the foot is coupled to a rotating support connected to a foot rotation motor and comprising an orifice for guiding a filament to the foot.

50. The filament feeding device of claim 48, wherein the foot is coupled to a rotating support connected to a foot rotation motor and the storage device further comprises instructions for adjusting the speed at which the foot rotation motor is actuated as a function of one or more position measurements and one or more of the speed of the traction motors and the pinch roller assembly motors.

51. The filament feeding device of claim 49, wherein the controller comprises instructions wherein the speed at which the foot rotation motor is actuated is a function of one or more measurements from the position sensor.

52. A method for guiding a filament into an additive manufacturing apparatus, comprising:
supplying the filament into a first tube telescoping into a second tube of the filament feeding;
measuring one or more positions of the first tube with respect to a reference point; and
adjusting a translation speed of the filament,
wherein adjusting the translation speed is a function of the one or more measurements of the position of the first tube, and
wherein adjusting a radiation supplied by a heater towards a portion of the filament travel path at a position ahead of the first tube as a function of one or more position measurements acquired from the position sensor.

53. A non-transitory computer-readable non-volatile storage device comprising computer executable instructions that, when executed by a controller of a filament feeding device causes the controller to at least:
acquire one or more position measurements from a position sensor configured to measure a position of a first tube telescoping into a second tube;
adjust the speed of a traction motor feeding a filament along a filament travel path into the first tube as a function of the one or more position measurements; and
adjust a radiation supplied by a heater towards a portion of the filament travel path at a position ahead of the first tube as a function of one or more position measurements acquired from the position sensor.

54. The storage device of claim 53, the computer executable instructions to further cause the controller to adjust the speed of one or more of the traction motor and a pinch roller assembly motor of an additive manufacturing apparatus into which the filament is fed from the second tube as a function of one or more measurements acquired from one or more position measurement acquisitions and one or more filament speed sensor measurement acquisitions.

55. The storage device of claim 54, the computer executable instructions to further cause the controller to rotate a foot of the additive manufacturing apparatus for depositing the filament onto an object surface.

56. The storage device of claim 55, the computer executable instructions to further cause the controller to adjust the speed of one or more of the traction motors and the pinch roller assembly motors comprise one or more function of one or more of the angles of rotation of the foot and the rate of rotation of the foot.
